(19) United States
(12) Patent Application Publication
(10) Pub. No.: US 2023/0107918 A1
(43) Pub. Date: Apr. 6, 2023

(54) EXCAVATOR SYSTEM FOR LOCATING AN UNDERGROUND UTILITY LINE

(71) Applicant: G.A.A.A. GLOBAL INFRASTRUCTURES TECHNOLOGIES LTD, Or Yehuda (IL)

(72) Inventors: Golan Ben Atia, Rosh Pina (IL); Opir Mazai, Zefat (IL)

(21) Appl. No.: 18/063,228

(22) Filed: Dec. 8, 2022

Related U.S. Application Data
(63) Continuation-in-part of application No. PCT/IL2021/050687, filed on Jun. 8, 2021.

(30) Foreign Application Priority Data
Jun. 11, 2020 (IL) 275318

(51) Int. Cl. E02F 5/00; E02F 9/26

(52) U.S. Cl. CPC E02F 5/003; E02F 9/262

(57) ABSTRACT

An excavator system for locating an underground utility line, the system comprising: a signal transmitter installed on the excavator; a signal receiver installed on the excavator; a monitor; and a control unit, in communication with the receiver, wherein the control unit is adapted (a) to analyze a vicinity of the receiver from the underground utility line by an intensity of a received signal by the receiver, and (b) to display indication of the vicinity on the monitor.

### TECHNICAL FIELD

The present invention relates to the field of underground utility locating machines.

### BACKGROUND

“Public utility systems are often run underground; some by the very nature of their function, others for convenience or aesthetics. Before digging, local governments often require that the underground systems' locations be denoted and approved, if it is to be in the public right-of-way.” (From Wikipedia)

Cutting an underground utility line may cause a “huge” damage, including disconnecting thousands of users from the electricity supply, water supply, Internet, gas, and the like. In order to prevent such damages, it is customary to take a number of preliminary steps, such as mapping the utility lines so that the excavator can be aware of these lines, getting permission from the appropriate authorities to dig at specific areas, etc.

“Because of the many different types of materials that go into manufacturing each of the different types of underground lines, different detection and location methods must be used. For metal pipes and cables, this is often done with electromagnetic equipment consisting of a transmitter and a receiver. For other types of pipe, such as plastic or concrete, other types of radiolocation or modern ground-penetrating radar must be used. Location by these technical means is necessary because maps often lack the pinpoint precision needed to ensure proper clearance. In older cities, it is especially a problem since maps may be very inaccurate, or may be missing entirely.

A few utilities are permanently marked with short posts or bollards, mainly for lines carrying petroleum products. This may be done because of venting requirements, and also serves to indicate the location of underground facilities that are especially hazardous if disturbed.” (From Wikipedia)

Examples of a device for detecting and locating an underground utility are the RIDGID SeekTech SR-60 Line Trace Product, wherein a demonstration of which can be seen at https://www.youtube.com/watch?v=ZfJ18fPk0Kg, or the RIDGID SR-24, wherein a demonstration of which can be seen at https://www.ridgid.com/au/en/sr-24-line-locator-with-bluetooth-and-gps, and many other.

Ground Penetrating Radar (GPR) is a geophysical technology that employs radar pulses to image the underground subsurface. This technology uses electromagnetic radiation waves for detecting reflected signals from subsurface structures.

Since the soil does not have to be disturbed, GPR is a safe and cost effective way to identify underground unknowns. GPR units consist of an antenna which transmits high frequency radio wave pulses and is dragged or rolled over the soil in a cart and a video screen and/or data logger to record all of the signals received.

All the methods described above have not yet provided satisfactory solutions to the problem of locating an underground utility.

It is an object of the present invention to provide a solution to the above-mentioned and other problems of the prior art.

Other objects and advantages of the invention will become apparent as the description proceeds.

### SUMMARY OF THE INVENTION

The term “excavator” refers herein to any underground digging machine, including excavators, plow machines, and so forth.

An excavator system for locating an underground utility line, the system comprising:
a signal transmitter installed on the excavator;
a signal receiver installed on the excavator;
a monitor; and
a control unit, in communication with the receiver, wherein the control unit is adapted to analyze a vicinity of the receiver from the underground utility line by an intensity of a received signal by the receiver, and to display indication of the vicinity on the monitor.

According to one embodiment of the invention, the signal is of electromagnetic waves, for detecting a utility line made of metal.
According to one embodiment of the invention, the receiver is installed on a cutting edge of a shovel bucket of the excavator and the signal is of ultrasound waves, for detecting a distance of the receiver from a utility line.

According to one embodiment of the invention, the signal is of ground-penetrating radar (GPR) technology.

According to one embodiment of the invention, the transmitter is disposed in a rear side of the excavator, and the receiver is disposed on an arm at the front side of the excavator, and the signal is of electromagnetic waves, the control unit being adapted to analyze a vicinity, depth, and geographical inclination of the utility line.

The system may further comprise an adaption to stop a digging movement of a shovel bucket of the excavator upon detecting that the shovel bucket is about to hit the utility line.

The system may be further adapted to display on the monitor an angle of the utility line with reference to the excavator.

The system may further comprise a compass, for detecting geographical orientation of the utility line.

The system may further comprise a GPS receiver, further comprising a GPS receiver, for geographically mapping said utility line and storing thereof in a database, and detecting a vicinity of said excavator to a utility line in said database, for warning thereof a driver of said excavator.

The system may further comprise a plurality of transmitters disposed at the side of the excavator.

The system may further comprise a plurality of transmitters disposed at the side of the excavator, each transmitting in a different frequency.

According to one embodiment of the invention, the system comprises a plurality of detection technologies such as electromagnetic wave, radar, and ultrasound waves, thereby providing a variety of detection abilities.

According to one embodiment of the invention, the transmitter and/or receiver is placed at an end of a rod connected to a body of the excavator, for keeping the transmitter and/or receiver distantly from the body, thereby diminishing influence of the body of the excavator on a signal transferred between the transmitter and the receiver.

According to one embodiment of the invention, the rod is adapted to change its location according to a state of an arm of the excavator to which it is connected.

According to one embodiment of the invention, the electromagnetic signal receiver is enveloped by electromagnetic shielding.

The electromagnetic shielding is preferably made of lead, but can be made from other materials, such as aluminum.

According to one embodiment of the invention, the database is a part of a municipal geographic information system, and available to other excavators.

The system may further comprise a recorder for recording a geographical location of the excavator at any given moment, the state of the present system, the state of the shovel bucket of the excavator, etc. (“black box”). The recorded information allows detecting whether the excavator hit a utility line, whether the driver thereof has been warned about the vicinity of the excavator to the utility line, the identity of the excavator driver, his driver, etc.

According to a further embodiment of the invention, the system comprises a camera for shooting stills and/or video images for analyzing accidents, and said recorder is adapted to store the images.

The foregoing embodiments of the invention have been described and illustrated in conjunction with systems and methods thereof, which are meant to be merely illustrative, and not limiting.

### BRIEF DESCRIPTION OF THE DRAWINGS

Preferred embodiments, features, aspects and advantages of the present invention are described herein in conjunction with the following drawings:

FIG. 1 pictorially illustrates a system for locating an underground utility, according to one embodiment of the invention.

FIG. 2a pictorially illustrates a state in which an excavator is parallel to a utility line, according to one embodiment of the invention.

FIG. 2b pictorially illustrates a state in which an excavator is perpendicular to a utility line, according to the same embodiment of the invention.

FIG. 3 pictorially illustrates a system for locating an underground utility, according to another embodiment of the invention.

FIG. 4 pictorially illustrates an excavator shovel bucket, according to one embodiment of the invention.

FIG. 5 pictorially illustrates a system for locating an underground utility, according to another embodiment of the invention.

FIG. 6 pictorially illustrates a system for locating an underground utility, according to one embodiment of the invention.

FIG. 7 pictorially illustrates an electromagnetic shielding of an electromagnetic signal receiver, according to one embodiment of the invention.

FIG. 8 is a block diagram schematically illustrating a system for locating an underground utility, according to another embodiment of the invention.

FIG. 9 is a block diagram schematically illustrating a system for locating an underground utility, according to another embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

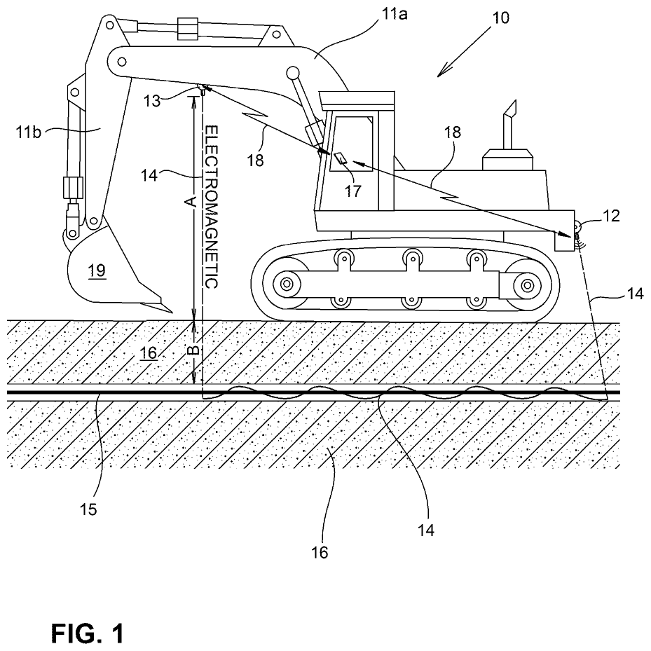

FIG. 1 pictorially illustrates a system for locating an underground utility, according to one embodiment of the invention.

The system includes an electromagnetic signals transmitter 12 disposed at the rear side of an excavator 10, a receiver 13 thereof disposed at the front side, preferably on an arm 11a, and a controller (not illustrated) using a monitor 17 with communication with the transmitter 12 and the receiver 13. The communication 18 may be wired as well as wireless.

The transmitter 12 transmits an electromagnetic signal 14 which passes through the utility line 15 disposed at underground 16, until it reaches to receiver 13.

The intensity of the electromagnetic signal determines whether the excavator 10 is parallel or perpendicular to the utility line 15.

This embodiment, which uses electromagnetic signals, suits for metal pipes and cables, such as electricity cables and communication cables.

The illustration marks two distances: a distance A between receiver 13 and the ground, and a distance B which is the depth of the utility line in the ground.

Thus, if distance A between the receiver and the ground is known, and the distance A+B (i.e., from the receiver 13 to the utility line 15) is also known, then also the distance B, i.e., the depth of the utility line, is known. In other words, the excavator's driver may be informed about the depth of the utility line, in order to be careful of the depth of the excavation.

Presently there are a variety of instruments for measuring such a distance. Such a device is referred to herein as distance-meter. Thus, even if the arm 11a changes its vertical position, the depth of the utility line can still be calculated.

Since in different conditions the transmission quality differs, according to one embodiment of the invention the user may select the transmission frequency.

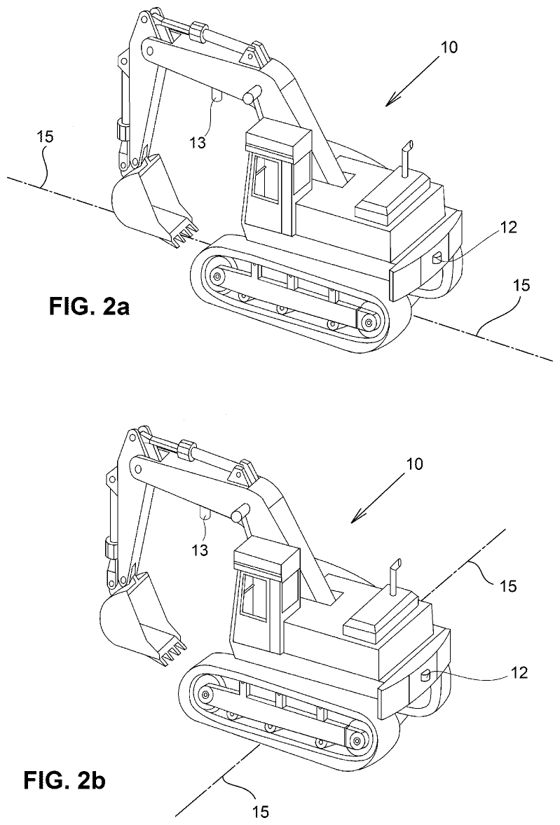

FIG. 2a pictorially illustrates a state in which an excavator is parallel to a utility line, according to one embodiment of the invention.

FIG. 2b pictorially illustrates a state in which an excavator is perpendicular to a utility line, according to the same embodiment of the invention.

In the situation of FIG. 2a, in which the imaginary line (not illustrated) between the transmitter and receiver installed on the excavator is parallel to the utility line 15 (from a top view), the electromagnetic signal received by the receiver is higher than the signal received by the receiver in FIG. 2b in which the imaginary line between the transmitter and receiver is perpendicular to the utility line 15.

Thus, by installing the transmitter 12 at the rear side of the excavator and the receiver 13 at the front side of the excavator, the vicinity of the receiver 13 to the utility line 15 can be detected.

Also the angle of the utility line 15 with the imaginary line between the transmitter and receiver of the excavator (from a top view) can be detected and presented to the driver of the excavator on a monitor.

Additionally, as mentioned, the depth of the utility line can be detected.

In addition, when the excavator's shovel bucket is above a utility line, the excavator's driver may be warned accordingly to take precaution steps, such as not digging beyond 1.5 meters deep. It should be noted that the majority of the utility lines are at a depth of 2-3 meters.

It should be noted that the excavator of this example is rotatable around a vertical axis (not illustrated). Thus, when the rotatable part of the excavator rotates, the transmitter 12 and receiver rotate as well, which means that the imaginary line also rotates.

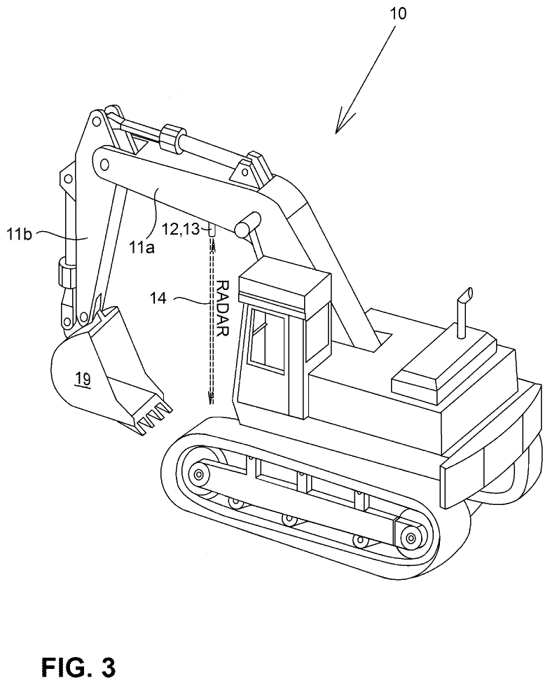

FIG. 3 pictorially illustrates a system for locating an underground utility, according to another embodiment of the invention.

According to this embodiment of the invention, a GPR is employed.

“Ground-penetrating radar (GPR) is a geophysical method that uses radar pulses to image the subsurface. This nondestructive method uses electromagnetic radiation in the microwave band (UHF/VHF frequencies) of the radio spectrum, and detects the reflected signals from subsurface structures. GPR can have applications in a variety of media, including rock, soil, ice, fresh water, pavements and structures. In the right conditions, practitioners can use GPR to detect subsurface objects, changes in material properties, and voids and cracks.

GPR uses high-frequency (usually polarized) radio waves, usually in the range 10 MHz to 2.6 GHz. A GPR transmitter emits electromagnetic energy into the ground. When the energy encounters a buried object or a boundary between materials having different permittivities, it may be reflected or refracted or scattered back to the surface. A receiving antenna can then record the variations in the return signal.” (From Wikipedia)

According to this embodiment of the invention, the transmitter and the receiver are disposed at the bottom side of arm 11a.

This technology may be used for non-metal utility lines as well as for metal utility lines.

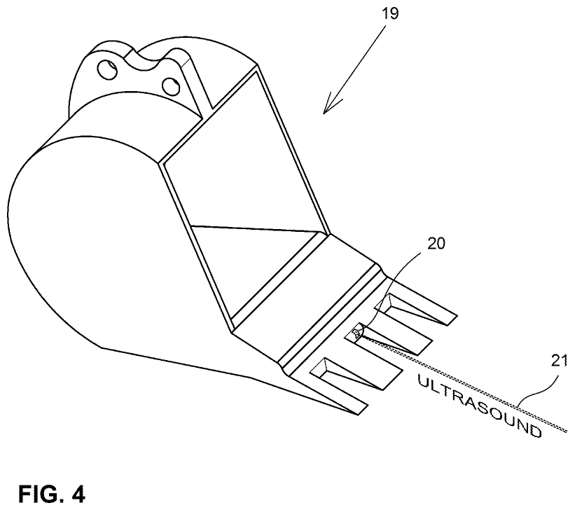

FIG. 4 pictorially illustrates an excavator shovel bucket, according to one embodiment of the invention.

Plastic and asbestos water pipes cannot be detected by electromagnetic signals, but they can be detected by ultrasound technology. However, since this technology is effective for a depth of about 20 to 50 cm, just placing an ultrasound scanner on an arm of an excavator cannot be adequate.

It comprises an ultrasound scanner 20 installed between the teeth of an excavator shovel bucket 19, i.e., at the cutting edge of the shovel bucket. Reference numeral 20 denotes ultrasound waves.

Due to the short range ultrasound technology is effective, the use of this technology is appropriate for detecting and stopping a shovel bucket before it hits a utility line, i.e., before damage is caused.

Thus, while the previous technologies described suit for detecting and mapping of utility lines, the ultrasound technology, which is effective in a depth of 20-50 cm, allows stopping the shovel bucket before damage is caused.

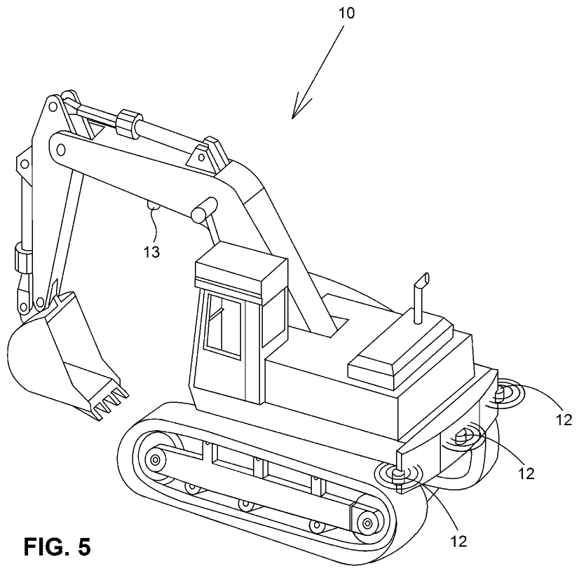

FIG. 5 pictorially illustrates a system for locating an underground utility, according to another embodiment of the invention.

The system employs electromagnetic signals.

According to this embodiment of the invention, three transmitters 12 are used, one disposed at the left side of the excavator 10, one at the rear-middle side thereof, and one at the right side thereof.

Each of the transmitters may transmit in a different frequency, thereby allowing the receiver 13 to distinguish between the transmitters.

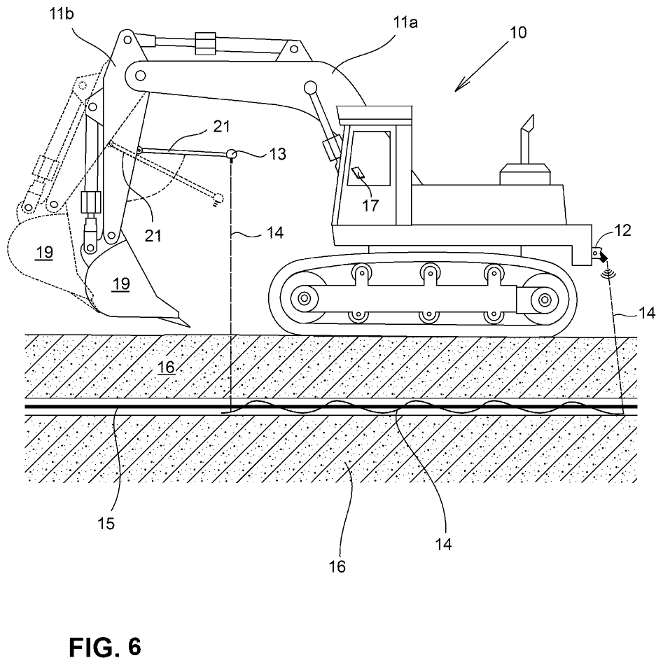

FIG. 6 pictorially illustrates a system for locating an underground utility, according to one embodiment of the invention.

The figure shows two states of arm 11b, one drawn in solid line, and one in dashed line.

In order to reduce the effect of the excavator's arms and metal parts on the magnetic signal 14, a rod 21 is used to keep sensor 13 distantly from the metal parts of the excavator. Furthermore, the excavator's shovel bucket 19 influence is reduced as well as it is not located between the vertical imaginary line between the sensing point (i.e., sensor 13) and the ground.

For obtaining this object, rod 21 may be fixed to arm 11b or to any other part of the excavator. Alternatively, the rod 21 may be rotatable (as illustrated in this figure). The rotatability also may prevent a collision between the rod and the other parts of the excavator. Thus, the rotation can depend on the state of the arm it is connected to.

The dependency may be mechanical (for example, the gravity changes the state of the rod), or controlled (for example, the rod changes its position according to the state of arm 11b).

The drawing illustrates two state of arm 11b. In this figure, rod 21 is fixed to arm 11b; however, as explained, the rod can be rotatable.

The same mechanism may be applied also for the transmitter 12. Thus, the transmitter 12 can be placed at an end of a rod, for keeping thereof distantly from the metal parts of the excavator.

This example refers to electromagnetic signal; however the same mechanism may be used for other signals.

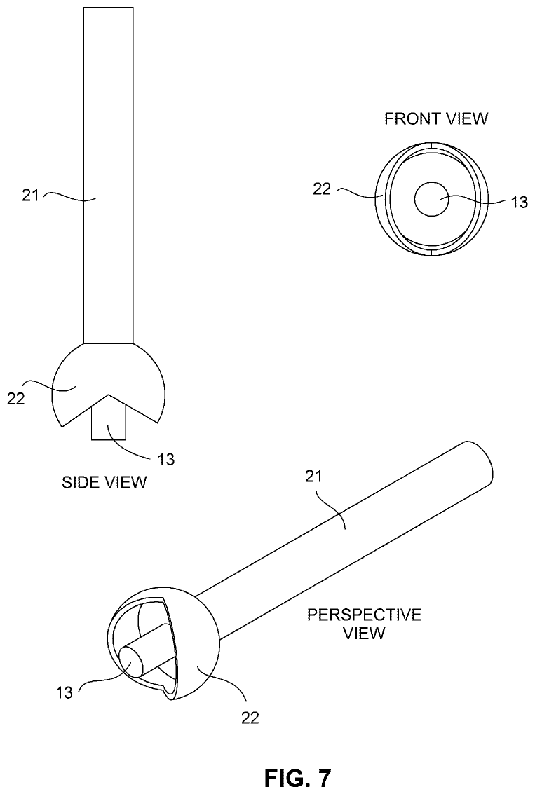

FIG. 7 pictorially illustrates an electromagnetic shielding of an electromagnetic signal receiver, according to one embodiment of the invention.

“Electromagnetic shielding is the practice of reducing the electromagnetic field in a space by blocking the field with barriers made of conductive or magnetic materials. Shielding is typically applied to enclosures to isolate electrical devices from their surroundings, and to cables to isolate wires from the environment through which the cable runs. Electromagnetic shielding that blocks radio frequency (RF) electromagnetic radiation is also known as RF shielding.” (From Wikipedia)

The electromagnetic shield 22 envelops the sensor from all its sides except from the aperture that exposes the sensor 13.

The figure illustrates an example of an electromagnetic shielding 22, which envelops an electromagnetic signal receiver 13 (sensor).

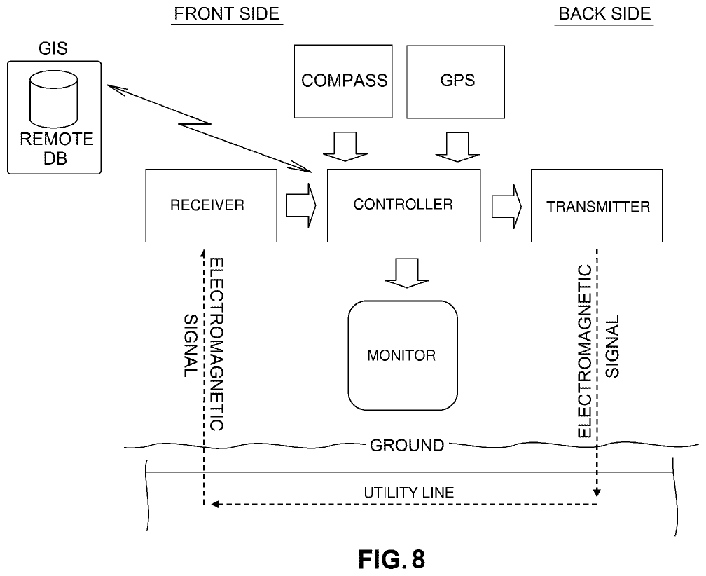

FIG. 8 is a block diagram schematically illustrating a system for locating an underground utility, according to one embodiment of the invention.

This embodiment suits for detecting a horizontal and vertical vicinity of a receiver thereof to a utility line made of metal, such as an electricity line.

The system uses a signal transmitter installed at the back side of an excavator, and a signal receiver installed at the front side of an excavator (i.e., at the shovel's side). The signal is of electromagnetic waves. A controller instructs the transmitter to transmit an electromagnetic signal (illustrated in the figure by a dashed line). As the system is near to a utility line made of metal, the signal passes through the utility line, received by the receiver, and then it is read by the controller.

According to the intensity of the received signal the controller estimates the distance between the utility line and the receiver.

Furthermore, since the geographical inclination of the excavator (more precisely, the angle between the imaginary line between the transmitter and the receiver) is known, the controller takes it into consideration in determining the geographic inclination of the utility line. Adding a GPS to the system allows geographic mapping the course of the utility line.

Preferably, the system is adapted to allow a user to set the frequency of the electromagnetic signal.

The communication of the transmitter and receiver with the controller may be carried out by wireless communication as well as wired communication.

A GPS receiver can also geographically map the detected utility line. Storing this information (i.e., utility line course) in a remote database, may be applied for further use. For example, by knowing that the utility lines of an area are mapped, a system that displays the utility lines on a map may help a driver of an excavator to avoid digging in vicinity to a utility line. Thus, a remote or local database may be used for storing the geographical information of the underground utility lines.

An example of a remote database is a municipal GIS (the acronym of Geographic Information System). “A geographic information system (GIS) is a conceptualized framework that provides the ability to capture and analyze spatial and geographic data. GIS applications (or GIS apps) are computer-based tools, that allow the user to create interactive queries (user-created searches), analyze spatial information output, edit datum presented within maps, and visually share the results of these operations.” (From Wikipedia) Such information can be provided to excavators and warn them on a vicinity to a utility line.

The geographic location where the excavator was at any moment can be transmitted to the municipal GIS, so that if a faulty infrastructure line is detected, it is possible to identify the excavator and its driver. Of course, not only the location, but the excavator driver's identity, etc. can be saved. Thus, the use of a GPS to locate the current geographic location of an excavator allows both, to map the utility lines of an area, and also detect the identity of an excavator that hits a utility line, and its driver. At the prior art such information is not available.

Additionally or alternatively, a recorder (“black box”) can store this information, and the activity of the warning system. According to the recording it is possible to detect an excavator that hit a utility line, whether the driver thereof has been warned, etc. Such information may be required for insurance matters.

The information can be transmitted to a municipal GIS later on, or just stored in the black box for a further use. The recorded information

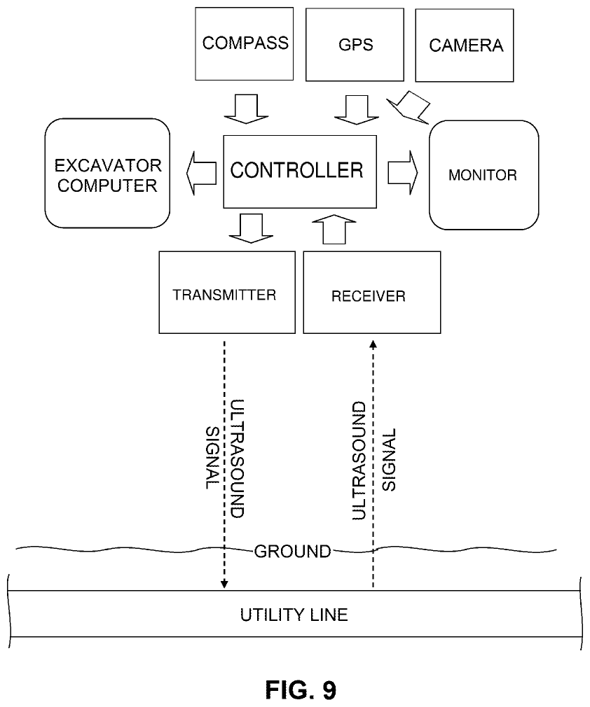

FIG. 9 is a block diagram schematically illustrating a system for locating an underground utility, according to another embodiment of the invention.

This embodiment suits for detecting the presence of an underground rigid object including a utility line, regardless of the material it is made of. As such, it can also suit for detecting plastic and asbestos water and sewer pipes. It also suits for detecting a geographical inclination of the utility line.

The system uses ultrasound waves. The transmitter and receiver are preferably installed on the cutting edge of a shovel bucket of the excavator.

Since this technology is effective for 20 to 50 cm, it is preferably used to stop the movement of the shovel's bucket before hitting a utility line. Thus, upon detecting the presence of a utility line at the shovel's bucket lane, the controller sends to the excavator's computer an instruction to stop the excavation, thereby preventing damage from the utility line.

Since each technology, electromagnetic or ultrasound signals, comprises its own advantages and drawbacks, two or more technologies may be combined in one system. For example, embedding electromagnetic signal transmission and ultrasound transmission in the same system may not only detect the course of the utility line, but also stop the shovel bucket from hitting the utility line.

The system may comprise also a camera and a recorder, to record images of the cameral. This way whenever an accident happens, the images can be used for investigating the accident. The recorder may record also the signals

In the figures and/or description herein, the following reference numerals (Reference Signs List) have been mentioned:
numeral 10 denotes an excavator;
each of numerals 11a and 11b denotes an arm of excavator 10;
numeral 12 denotes an electromagnetic signal transmitter;
numeral 13 denotes an electromagnetic signal receiver;
numeral 14 denotes an electromagnetic signal;
numeral 15 denotes a utility line;
numeral 16 denotes the ground (soil);
numeral 17 denotes a monitor;
numeral 18 denotes communication;
numeral 19 denotes an excavator shovel bucket;
numeral 20 denotes an ultrasound scanner; and
numeral 21 denotes a rod on which is disposed the electromagnetic signal receiver 13.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

1. An excavator system for locating an underground utility line, the excavator system comprising:
a signal transmitter installed on said excavator;
a signal receiver installed on said excavator;
a monitor; and
a control unit, in communication with said signal receiver, wherein said control unit is adapted to analyze a vicinity of said receiver from said underground utility line by an intensity of a received signal by said signal receiver, and to display indication of said vicinity on said monitor.

2. The excavator system according to claim 1, wherein said signal is of electromagnetic waves, for detecting a utility line made of metal.

3. The excavator system according to claim 1, wherein said signal receiver is installed on a cutting edge of a shovel bucket of said excavator and said signal is of ultrasound waves, for detecting a distance of said signal receiver from a utility line.

4. The excavator system according to claim 1, wherein said signal is of ground-penetrating radar (GPR) technology.

5. The excavator system according to claim 1, wherein said signal transmitter is disposed in a rear side of said excavator, and said receiver is disposed on an arm at the front side of said excavator, and said signal is of electromagnetic waves, and said control unit is adapted to analyze a vicinity, depth, and geographical inclination of said utility line.

6. The excavator system according to claim 1, further comprising an adaption to stop a digging movement of a shovel bucket of said excavator upon detecting that said shovel bucket is about to hit said utility line.

7. The excavator system according to claim 1, further adapted to display on said monitor an angle of said utility line with reference to said excavator.

8. The excavator system according to claim 1, further comprising a compass, for detecting geographical orientation of said utility line.

9. The system according to claim 1, further comprising a GPS receiver, for geographically mapping said utility line and storing thereof in a database, and detecting a vicinity of said excavator to a utility line in said database, for warning a driver of said excavator.

10. The excavator system according to claim 1, further comprising a plurality of transmitters disposed at the side of said excavator.

11. The excavator system according to claim 1, further comprising a plurality of transmitters disposed at the side of said excavator, each transmitting at a different frequency.

12. The system according to claim 1, further comprising a plurality of detection technologies selected from a group comprising: electromagnetic waves, radar, and ultrasound waves.

13. The excavator system according to claim 1, wherein said signal transmitter and/or signal receiver is placed at an end of a rod connected to a body of said excavator, for keeping said signal transmitter and/or signal receiver distantly from said body, thereby diminishing influence of said body on a signal transferred between said signal transmitter and said signal receiver.

14. The excavator system according to claim 13, wherein said rod is adapted to change a location thereof according to a state of an arm of said excavator to which said rod is connected.

15. The excavator system according to claim 1, wherein said signal receiver is an electromagnetic signal receiver and is enveloped by an electromagnetic shield.

16. The excavator system according to claim 15, wherein said electromagnetic shield envelops the electromagnetic signal transmitter from all sides except from an aperture that exposes the transmitter.

17. The excavator system according to claim 1, wherein said signal transmitter is an electromagnetic signal transmitter and is enveloped by an electromagnetic shield.

18. The excavator system according to claim 15, wherein said electromagnetic shield envelops the electromagnetic signal receiver from all sides except from an aperture that exposes the receiver.

19. The excavator system according to claim 15, wherein said electromagnetic shield is made of lead or aluminum.

20. The excavator system according to claim 9, wherein said database is a part of a municipal geographic information system, and available to other excavators.

21. The excavator system according to claim 9, further comprising a recorder for recording a member of a group consisting of: geographical location of the excavator at any given moment, a height of a shovel bucket of said excavator, thereby allowing detecting a member of a group consisting of: whether said excavator hit a utility line, whether a driver thereof has been warned about vicinity of said excavator to said utility line, an identity of said excavator driver.

22. The excavator system according to claim 18, further comprising a camera for shooting stills and/or video images, wherein said recorder is adapted to store said images.
